(19) United States
(12) Patent Application Publication
(10) Pub. No.: US 2011/0093891 A1
(43) Pub. Date: Apr. 21, 2011

(54) INFORMATION PROCESSING APPARATUS AND VIDEO CONTENT DATA PLAYBACK METHOD

(75) Inventor: Seiichi Nakamura, Inagi-shi (JP)

(73) Assignee: KABUSHIKI KAISHA TOSHIBA, Tokyo (JP)

(21) Appl. No.: 12/909,538

(22) Filed: Oct. 21, 2010

(30) Foreign Application Priority Data
Oct. 21, 2009 (JP) 2009-242663

(51) Int. Cl. H04N 5/445; H04N 7/24; H04N 7/26

(52) U.S. Cl. 725/38; 375/240.26; 375/E07.019; 375/E07.026

(57) ABSTRACT

According to one embodiment, an information processing apparatus is configured to execute player software for decoding encoded video content data received from a server. The information processing apparatus includes a display device, a capture module, an encoder, and a transfer module. The display device is configured to display video of the decoded video content data. The capture module is configured to capture the decoded video content data. The encoder is configured to encode the captured video content data. The transfer module is configured to transfer the encoded video content data to an electronic device configured to play back video content data received from an external device.

### CROSS-REFERENCE TO RELATED APPLICATIONS

This application is based upon and claims the benefit of priority from Japanese Patent Application No. 2009-242663, filed Oct. 21, 2009; the entire contents of which are incorporated herein by reference.

### FIELD

Embodiments described herein relate generally to an information processing apparatus which plays back video content received from a server, and a video content data playback method applied to this apparatus.

### BACKGROUND

In recent years, it has been widely practiced to view, with use of a browser of a personal computer, various video contents, such as video clips or home movies, which are made public on a video delivery site on the Internet. A video playback program embedded in the browser as plug-in software decodes the video content data received from the video delivery site. Video of the decoded video content data is displayed on a display under the control of the operating system.

In addition, recently, techniques have begun to be developed for transmitting various contents, such as video and still images, to a TV, and displaying the contents on the screen of the TV.

However, the video content data, which is downloadable from the video delivery site, comprises video content data encoded by various encoding schemes, whereas the kinds of encoding schemes, which can be handled by electronic devices such as TVs, are, in many cases, limited to some encoding schemes such as MPEG2 and WMV.

Thus, in the electronic devices such as TVs, it is difficult to directly handle the video content data received from servers for computers, such as video delivery sites on the Internet.

Jpn. Pat. Appln. KOKAI Publication No. 2005-27053 discloses a personal computer which transmits content data to a TV. This personal computer converts content data, which is stored in a storage device in a computer, to a data broadcast format such as BML, and transmits to a TV the content data which has been converted to the data broadcast format.

In this computer, however, it is assumed that the format of the content, which is already stored in the storage device, is converted. No consideration is given to such a use mode that video content, which is received from a video delivery site, is viewed by an electronic device such as a TV.

A streaming technique is used, in many cases, for delivering video content data from the video delivery site. In this case, in general, the video content data received from the video delivery site cannot be stored as a data file in a local storage device in the computer.

It is thus desirable to realize a novel technique for enabling viewing of video content data of various encoding schemes, not only by an information processing apparatus such as a computer, but also by an electronic device such as a TV, when the video content data is received from a server such as a video delivery site.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 shows a structure example of a home network system comprising an information processing apparatus according to an embodiment;

FIG. 2 illustrates a state in which while the information processing apparatus of the embodiment is receiving content data from a server such as a video delivery site, the content data is played back by an electronic device such as a TV;

FIG. 3 is an exemplary block diagram showing an example of the system configuration of the information processing apparatus according to the embodiment;

FIG. 4 is an exemplary block diagram showing an example of a software configuration for realizing a streaming function of the information processing apparatus according to the embodiment;

FIG. 5 illustrates an example of a browser window comprising a video display area displayed by a browser on a display screen of the information processing apparatus according to the embodiment;

FIG. 6 illustrates an example of a graphical user interface (GUI) layer used in the information processing apparatus according to the embodiment;

FIG. 7 is an exemplary view for describing a first icon (button) displayed on a GUI screen of the information processing apparatus according to the embodiment;

FIG. 8 is an exemplary view illustrating an example of the layout of a first icon (button) and a plurality of second icons (buttons), which are displayed on the GUI screen of the information processing apparatus according to the embodiment; and

FIG. 9 is an exemplary flow chart illustrating the procedure of a streaming process executed by the information processing apparatus according to the embodiment.

### DETAILED DESCRIPTION

Various embodiments will be described hereinafter with reference to the accompanying drawings.

In general, according to one embodiment, an information processing apparatus is configured to execute player software for decoding encoded video content data received from a server. The information processing apparatus comprises a display device, a capture module, an encoder, and a transfer module. The display device is configured to display video of the decoded video content data. The capture module is configured to capture the decoded video content data. The encoder is configured to encode the captured video content data. The transfer module is configured to transfer the encoded video content data to an electronic device configured to play back video content data received from an external device.

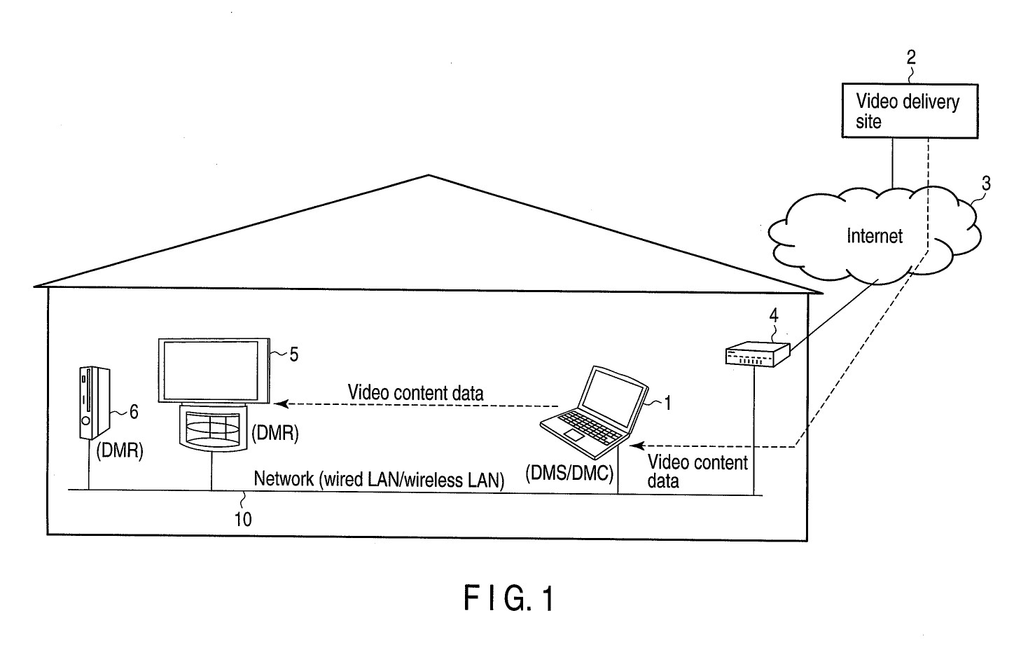

FIG. 1 shows a structure example of a network system comprising an information processing apparatus according to an embodiment. This network system is a home network for interconnecting various electronic devices in the home, such as a consumer device, a portable device and a personal computer. The information processing apparatus is realized, for example, as a notebook-type personal computer (PC) 1.

The personal computer (PC) 1 is connected to a network 10 in order to communicate with other electronic devices in the home. The network 10 is composed of, for example, a wired LAN or a wireless LAN. A TV 5, a game machine 6 and other various electronic devices are connected to the network 10.

Furthermore, a communication device 4, such as a broadband modem or a broadband router, is connected to the network 10. The personal computer 1 can access Web sites on the Internet 3 via the communication device 4. The Web sites comprise a video delivery site 2 for sharing video content data, such as home video created by users. The video delivery site 2 makes public various video content data, such as video clips and home video, which are uploaded by users. The user of the personal computer 1 can play back, while receiving via the Internet 3, video content data which can be provided by the video delivery site 2. The access to the video delivery site 2 is executed by software, for example, a browser (WWW browser) executed by the computer 1. The video content data on the video delivery site 2 comprises various video content data which are encoded by various encoding schemes. The reception and playback of the video content data from the video delivery site 2 are executed, for example, by a video playback program plugged in the browser. This video playback program is player software for decoding the encoded video content data received from a server such as the video delivery site 2. The video of the video content data, which has been decoded by the video playback program, is displayed on the display device of the personal computer 1 under the control of the operating system.

The reception and playback of video content data are executed, for example, by using streaming. The video playback program, while receiving video content data from the video delivery site 2, decodes the received video content data.

The computer 1 has a UPnP (universal plug and play) function for recognizing the presence of devices on the network 10, and exchanging their functions (capabilities). Further, by using the UPnP function, the computer 1 can function as a home network device which is stipulated, for example, by the guideline of DLNA (Digital Living Network Alliance). Home network devices are classified into categories of, for instance, a digital media server (DMS), a digital media player (DMP), a digital media controller (DMC) and a digital media renderer (DMR).

The digital media server (DMS) is a device which provides content data stored in a storage unit in the digital media server (DMS) to the digital media player (DMP) in response to a request from a digital media player (DMP). The digital media controller (DMC) is a device which controls a device such as a digital medial renderer (DMR). The digital media renderer (DMR) is a device playing back content data received from the digital media server (DMS), under the control of the digital media controller (DMC). The content data, which is to be received and played back by the digital media renderer (DMR), is instructed to the digital media renderer (DMR) by the digital media controller (DMC).

The computer 1 can function as both the digital media server (DMS) and the digital media controller (DMC). Each of the TV 5 and game machine 6 can function as the digital media renderer (DMR).

In addition, the computer 1 of the embodiment has a function (hereinafter referred to as “streaming function”) of providing, while receiving video content data from the video delivery site 2, the video content data in real time to the digital media renderer (DMR), for instance, the TV 5 or game machine 6. The streaming function enables the user to search desired content from the video delivery site 2 on the Internet 3 by making use of a computer with a high operability with respect to Internet browsing, and to display the searched content on the large screen of the TV 5.

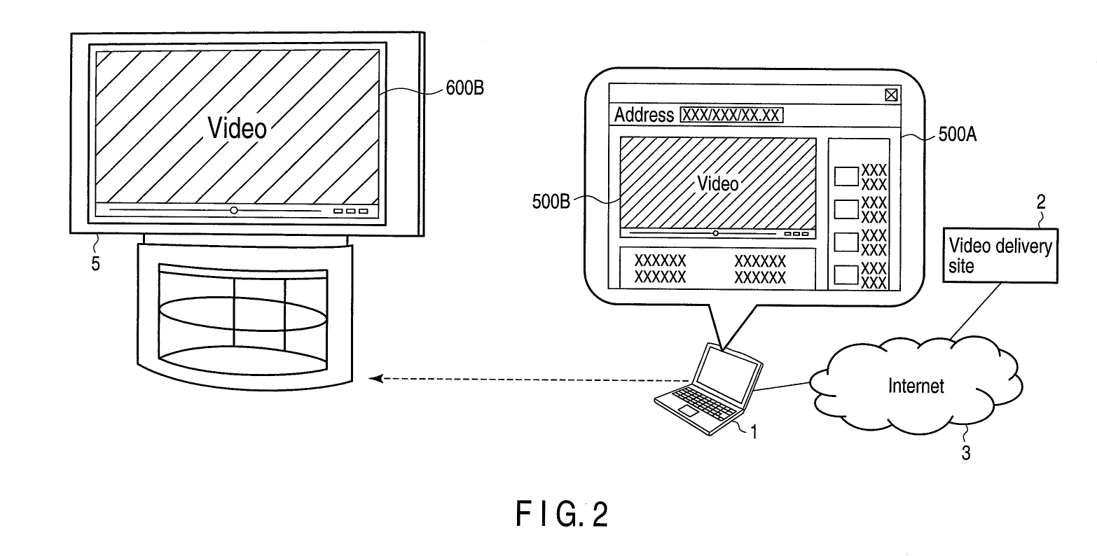

FIG. 2 illustrates a state in which while the computer 1 is receiving content data from the video delivery site 2, the video content data is played back by the electronic device such as the TV 5.

The screen of the display of the computer 1 displays a window 500A of the browser. As has been described above, the decode and playback of the video content data, which is received from the video delivery site 2, are executed by the video playback program plugged in the browser. The video content data comprises, for instance, encoded video data and encoded audio data. The video playback program decodes the video data and audio data and outputs the decoded video data and audio data. Video (moving image) corresponding to the decoded video data is displayed on a video window 500B disposed within the window 500A of the browser. Needless to say, the video window 500B can be displayed in a full-screen mode on the display screen of the computer 1.

If an event instructing execution of the streaming function occurs in response to a user operation while video content data is being played back, the computer 1 starts a streaming process in order to transfer the video content data, which is currently being received and played back, to the TV 5. In the streaming process, to begin with, the computer 1 captures the video content data decoded by the video playback program (e.g. a stream of video data obtained by the decode and a stream of audio data obtained by the decode), and encodes the captured video data stream and audio data stream. For the encoding, use is made of a codec (encoding scheme, e.g. MPEG-2) which enables the DMR device (e.g. TV 5) on the network to execute decoding.

The reason why the output of the video playback program (the decoded video data and decoded audio data), and not the video content data received from the video delivery site 2, is captured is that the video content data can easily be converted to video content data which can be played back by the DMR device, without taking care of the kind of the codec applied to the received video content data (i.e. the kind of the encoding scheme of the video data and audio data in the content data). The parse (analysis) of the video content data received from the video delivery site 2 and the process of synchronizing the video data and audio data have already been executed by the video playback program. Thus, the video content data, which can be played back by the DMR device, can easily be generated by simply encoding the output of the video playback program.

The computer 1 instructs the TV 5 via the network 10 to play back the video content data generated by encoding the output of the video playback program. Then, the computer 1 transfers the video content data to the TV 5 via the network 10. In this case, the HTTP protocol or other various general-purpose protocols can be used for the transfer of the video content data from the computer 1 to the TV 5. Responding to a playback instruction from the computer 1, the TV 5 starts a process of receiving the video content data, the playback of which has been instructed, from the computer 1, and decodes the encoded video data and encoded audio data comprised in the received video content data, thereby playing back the decoded video data and audio data.

The video (moving image) corresponding to the decoded video data is displayed on a display screen 600B of the TV 5. Not the entire image in the window 500A of the browser, but only the video on the video window 500B is displayed on the display screen 600B of the TV 5. Thus, the user can enjoy only the video on the large screen. The sound corresponding to the decoded audio data is produced, for example, from a speaker provided on the TV 5.

If the TV 5 is in the process of viewing of TV broadcast program data, the TV 5 automatically switches the content data, which is the target of viewing, from the broadcast program data to the content data transmitted from the computer 1.

Thus, while searching and playing back the video content on the video delivery site 2 by operating the computer 1, the user can cause the TV 5 to play back the currently received and played-back video content.

In general, since the size (resolution) of the display screen of the TV 5 is larger than the size of the display screen of the computer 1, the above-described streaming function enables the user or the whole family to view the video content data on the video delivery site 2. The streaming function can be executed by simply operating the computer 1, without the need to operate the TV 5 itself.

Recently, there has been developed a TV having a browser function for accessing sites on the Internet. However, it is not always easy for persons, who are not familiar with the operation of computers, to use the browser function of the TV. Besides, in usual cases, the operability of the browser function of the TV is lower than that of the browser function of the computer.

In the present embodiment, if a person in the family is familiar with the operation of computers, this person may operate the computer 1, thereby making it possible to display the video received from the Internet on the large display screen of the TV 5. Thus, without accessing a WEB site from the TV 5, the family can enjoy the video searched from the Internet 3, by making use of the computer 1 with high operability.

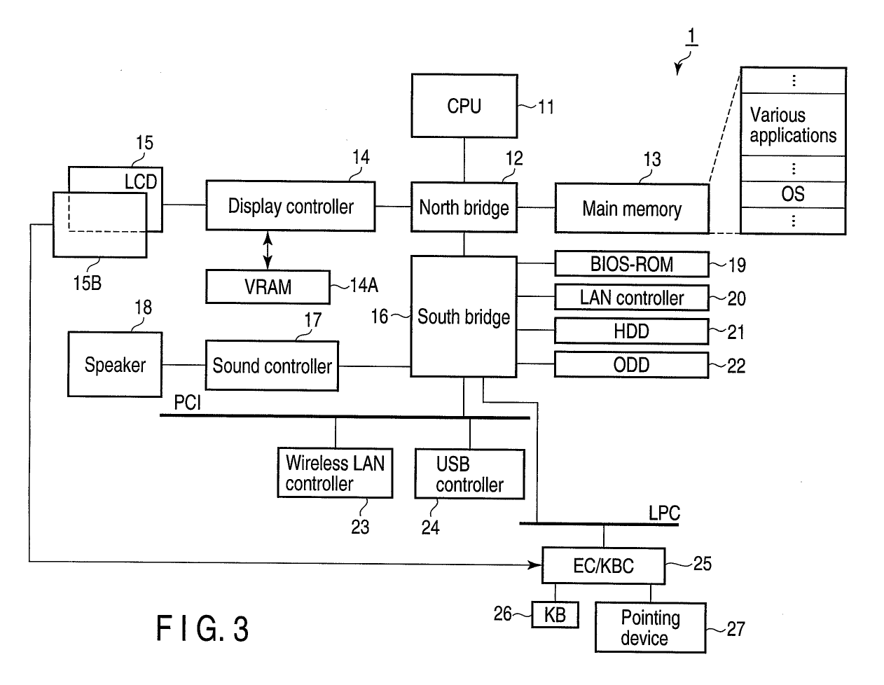

FIG. 3 shows the system configuration of the computer 1.

As shown in FIG. 3, the computer 1 comprises a CPU 11, a north bridge 12, a main memory 13, a display controller 14, a video memory (VRAM) 14A, an LCD (Liquid Crystal Display) 15, a south bridge 16, a sound controller 17, a speaker 18, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, a keyboard (KB) 26 and a pointing device 27.

The CPU 11 is a processor which controls the operation of the computer 1. The CPU 11 executes an operating system (OS) and various application programs, which are loaded from the HDD 21 into the main memory 13. The application programs comprise the above-described browser and video playback program. Further, the application programs comprise the software for executing the above-described streaming function. The CPU 11 also executes a BIOS (Basic Input/Output System) that is stored in the BIOS-ROM 19. The BIOS is a program for hardware control.

The north bridge 12 is a bridge device that connects a local bus of the CPU 11 and the south bridge 16. The north bridge 12 comprises a memory controller that access-controls the main memory 13. The north bridge 12 has a function of executing communication with the display controller 14.

The display controller 14 is a device which controls the LCD 15 that is used as a display of the computer 1. The LCD 15 is realized as a touch screen device which can detect a position touched by a pen or finger. Specifically, a transparent coordinate detection module 15B, which is called “tablet” or “touch panel”, is disposed on the LCD 15.

The south bridge 16 controls the devices on a PCI (Peripheral Component Interconnect) bus and an LPC (Low Pin Count) bus. In addition, the south bridge 16 comprises an IDE (Integrated Drive Electronics) controller for controlling the HDD 21 and ODD 22, and a memory controller for access-controlling the BIOS-ROM 19. Furthermore, the south bridge 16 has a function of communicating with the sound controller 17 and LAN controller 20.

The sound controller 17 is a sound source device, and outputs audio data, which is to be played back, to the speaker 18. The LAN controller 20 is a wired communication device which executes wired communication according to, e.g. the Ethernet (trademark) standard. The wireless LAN controller 23 is a wireless communication device which executes wireless communication of, e.g. the IEEE 802.11 standard. The USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the computer 1 in response to the user's operation.

The computer 1 having the above-described structure operates to download via the Internet the content data, which is provided by the video delivery site 2 shown in FIG. 1, by the programs (OS and various applications) which are loaded from the HDD 21 into the main memory 13 and are executed by the CPU 11, and to play back the downloaded content data.

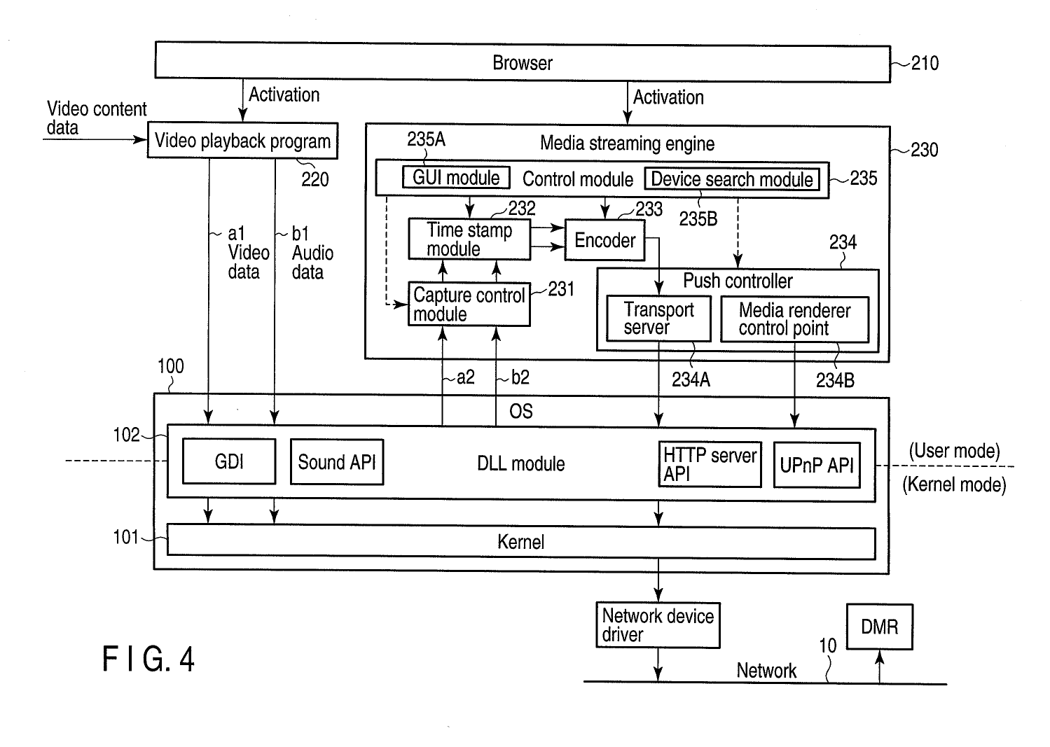

Next, referring to FIG. 4, a description is given of the software configuration used in order to execute the above-described streaming function.

As shown in FIG. 4, an OS 100, a browser 210, a video playback program 220 and a media streaming engine 230 are installed in the computer 1. Each of the video playback program 220 and the media streaming engine 230 is embedded in the browser 210 as plug-in software.

The OS 100, which executes resource management of the computer 1, comprises a kernel 101 and a dynamic link library (DLL) 102. The kernel 101 is a module which controls the respective components (hardware) of the computer 1 shown in FIG. 2, and the DLL 102 is a module which provides the application program with an interface with the kernel 101. The DLL 102 comprises a GDI (graphical device interface), a sound API, an HTTP server API, and an UPnP-API, the GDI being an API relating to a graphics process and the sound API relating to a sound process.

The hierarchical level up to the stage at which the various application programs issue to the DLL 102 various requests to the kernel 101 is referred to as “user mode”, and the hierarchical level from the stage at which the DLL 102 transmits these requests to the kernel 101 is referred to as “kernel mode”.

When the browser 210 accesses the Web page of the video delivery site 2, the browser 210 detects, according to the tag information in this Web page, that the Web page is a Web page comprising content such as video. Then, the browser 210 starts the video playback program 220 incorporated in the browser 210 as plug-in software. If the user performs an operation of instructing the playback of content, such as video, while viewing the Web page, the video playback program 220 begins to receive the video content data from the video delivery site 2.

The video playback program 220, while receiving the video content data, decodes in parallel the video data and audio data comprised in the video content data. The video playback program 220 delivers to the DLL 102 of the OS 100 a stream al of video data obtained by the decoding and a stream b1 of audio data obtained by the decoding, thereby to enable video output (by the LCD 15) and audio output (by the speaker 18).

In usual cases, the video data al and audio data b1, which are delivered to the DLL 102, are subjected to a process of, e.g. a format check in the DLL 102, and then the processed data are supplied to the kernel 101. The kernel 101, based on the supplied data, executes video output from the LCD 15 and audio output from the speaker 18. The format check and other various processes on the video data a1 may be executed by, e.g. the GDI, and the format check and other various processes on the audio data b1 may be executed by, e.g. the sound API.

The media streaming engine 230 is a program plugged in the browser 210 as resident plug-in software. In accordance with the start-up of the browser 210, the media streaming engine 230 is automatically activated. In order to execute the above-described streaming function, the media streaming engine 230 has the following functions:

1. A function for searching a DMR device on the network 10 (DMR is an electronic device which can play back video content data received from an external device such as a DMS);

2. A function for capturing an output of the video playback program 220 via the DLL 102;

3. A function for encoding the captured video data and audio data by an encoding scheme such as MPEG-2 or WMV; and

4. A function for transferring video content data comprising the encoded video data and encoded audio data to the DMR device such as TV 5.

In order to realize these functions, the media streaming engine 230 comprises a capture control module 231, a time stamp module 232, an encoder 233, a push controller 234 and a control module 235.

The capture control module 231 captures the video data a1 and audio data b1 which are output from the video playback program 220. Since the video playback program 220 outputs the video data a1 and audio data b1 to the OS 100, the capture control module 231 can capture, via the OS 100, the video data a1 and audio data b1 which are output from the video playback program 220. For example, the capture of the video data a1 and audio data b1 may be executed by rewriting a part of the routine in the DLL 102. In this case, the routine in the DLL 102, which handles the video data a1 and audio data b1, may be rewritten to a new routine which additionally comprises a procedure for delivering copy data of the video data a1 and audio data b1 to the media streaming engine 230. This new routine delivers the video data a1 and audio data b1, which are output from the video playback program 220, to the kernel 101, and also delivers video data a2 and audio data b2, which are copies of the video data a1 and audio data b1, to the media streaming engine 230.

For example, when the media streaming engine 230 is activated, the capture control module 231 asks the browser 210 to notify the media streaming engine 230 of the start of the video playback program 220. When this notification is received, the capture control module 231 executes rewrite of the routine in the DLL 102 (e.g. a part of the GDI, a part of the sound API, etc.).

In the meantime, a software module, which can execute a first function of (i) delivering the video data a1 and audio data b1 to the kernel 101 and a second function of (ii) capturing the video data a1 and audio data b2 and delivering the captured video data and audio data to the media streaming engine 230, may be provided in the DLL 102 in advance, and the enable/disable of the second function may be controlled by the capture control module 231 of the media streaming engine 230.

By the above-described function of the capture control module 231, the time stamp module 232 can receive the video data a2 and audio data b2 from the DLL 102. The time stamp module 232 is a module which adds time information indicative of the timing, at which the video data a2 and audio data b2 are received, to the video data a2 and audio data b2. The time information may be a value which enables discrimination of time. For example, as the time information, use may be made of a system time of the computer 1, or time count data which begins to be counted up after the activation of the media streaming engine 230.

The video data a2 and audio data b2, to which the time information has been added by the time stamp module 232, is delivered to the encoder 233. The encoder 233 encodes the video data a2 and audio data b2. Based on the time information added by the time stamp module 232, the encoder 233 multiplexes the encoded video data and encoded audio data, thereby generating video content data comprising a bit stream in which the encoded video data and encoded audio data are multiplexed.

The push controller 234 instructs, via the network 10, the DMR device (e.g. TV 5) to play back the video content data generated by the encoder 233, and transfers the video content data to the DMR device (e.g. TV 5) via the network 10. The push controller 234 comprises a transport server 234A and a media renderer control point 234B. The media renderer control point 234B is a module functioning as the above-described DMC, and transmits via the network 10 to the DMR device a control message which instructs playback of the video content data generated by the encoder 233. This control message is sent to the DMR device (e.g. TV 5) via the OS 100, a network device driver and the network 10. The transport server 234A is a module which transmits the video content data, which is generated by the encoder 233, to the DMR device (e.g. TV 5). The transmission of the content data is executed, for example, by using communication between the HTTP-API in the DLL 102 and the DMR device (e.g. TV 5).

The control module 235 controls the respective elements in the media streaming engine 230. The control module 235 displays a graphical user interface on the touch screen (the screen of the LCD 15), and controls, according to an operation of the graphical user interface by the user, the start and stop of the transfer of the video content data to the TV 5, or, to be more specific, the start and stop of the streaming function.

The control module 235 comprises a graphical user interface (GUI) module 235A and a device search module 235B. The device search module 235B executes, in cooperation with the UPnP-API in the DLL 102, a process for searching (discovering) a DMR device on the network 10. The graphical user interface (GUI) module 235A displays on the touch screen (the screen of the LCD 15) a GUI for enabling the user to control the above-described streaming function, and controls the execution of the streaming function in accordance with the user's operation on the GUI. The user operates the pointing device 27 or performs a touch operation on the touch screen by the finger, thus being able to give an instruction for controlling the streaming function (e.g. an instruction to start/end steaming, or an instruction to select the DMR device) to the media streaming engine 230.

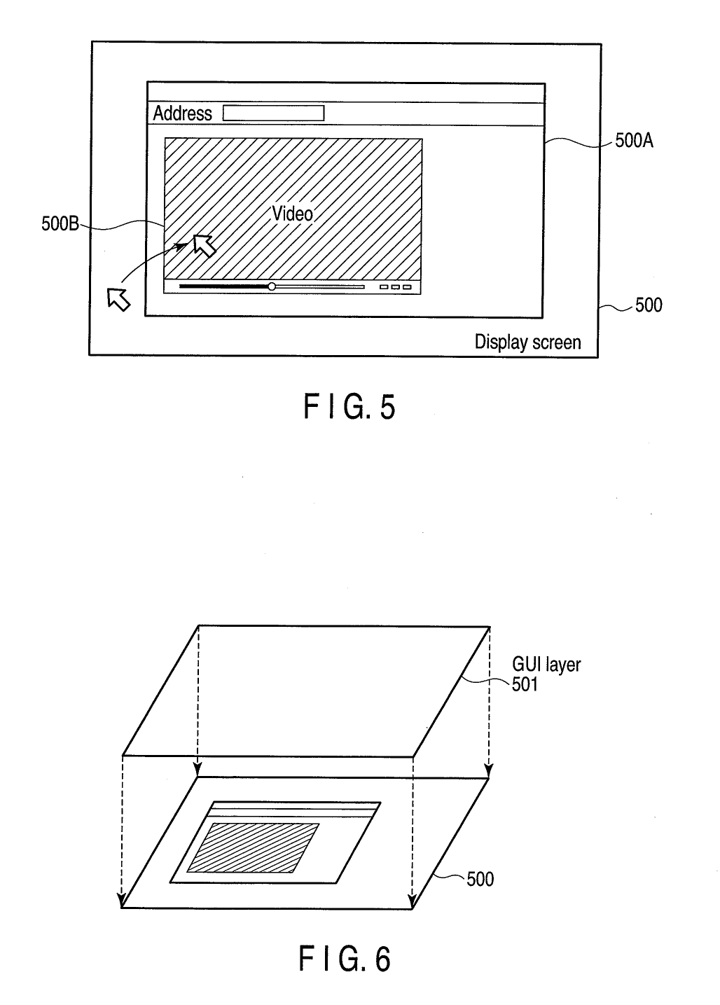

Next, referring to FIG. 5 to FIG. 8, an example of the GUI for enabling the user to control the streaming function is described.

FIG. 5 shows an example of a display screen (desktop screen) 500 of the LCD 15 of the computer 1. A window 500A of the browser 210 is displayed on the display screen 500 of the computer 1. If the playback of the video data is started by the video playback program 220, video (moving image) corresponding to the video data is displayed on a video window 500B disposed in the window 500A. When a mouse cursor is moved onto the video window 500B according to the user's operation of the pointing device 27, or when a position on the video window 500B is touched by the finger, the graphical user interface (GUI) module 235A starts display of the GUI. As shown in FIG. 6, a layer 501, which is different from the display screen 500, is used for the display of the GUI. The GUI layer 501 has the same size as the display screen 500. The graphical user interface (GUI) module 235A displays the above-described GUI on the display screen 500 by rendering an object, such as an icon, on the GUI layer 501. In the GUI layer 501, the entire area excluding an area, where the object, such as an icon, is rendered, is set to be transparent so that the content of the display screen 500 can be viewed. By using the GUI layer 501, the object, such as an icon, for the GUI can be displayed on the video window 500B or window 500A, or on the outside of the window 500A.

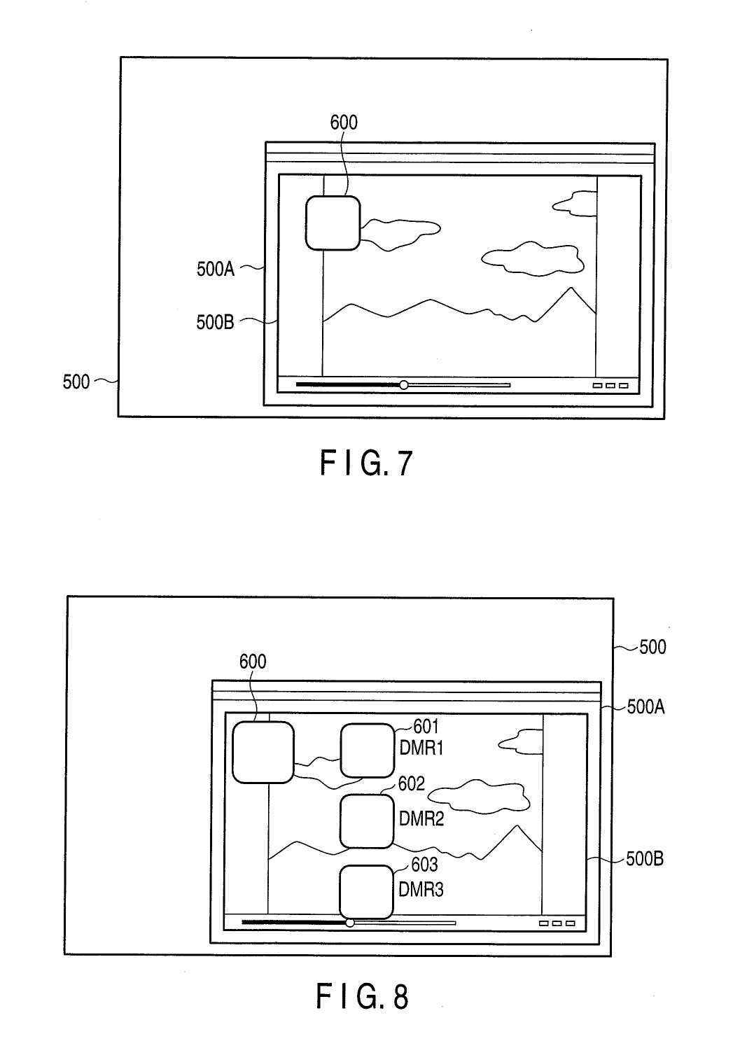

When the mouse cursor is moved onto the video window 500B or when an area on the touch screen, which corresponds to the display position of the video window 500B, is touched by the finger, the graphical user interface (GUI) module 235A displays, as shown in FIG. 7, a first icon (button) 600 on the display screen 500, for example, on the video window 500B. The first icon (button) 600 is used in order to notify the user that an operation of video on the video window 500B (in this example, the execution of the streaming function) can be performed. The first icon 600 is associated with the video currently played back on the video window 500B.

When the first icon 600 is selected by the user's touch operation or by the operation of the pointing device, the device search module 235B of the control module 235 searches a DMR device on the network 10. Then, as shown in FIG. 8, the graphical user interface (GUI) module 235A displays second icons (buttons), which are associated with all DMR devices discovered by the search process, on the display screen 500, for example, on the video window 500B. In FIG. 8, the case is assumed in which three DMR devices DMR1, DMR 2 and DMR3 have been discovered. In this case, three second icons 601, 602 and 603, which are associated with the three DMR devices, are displayed near the first icon 600. Each second icon is accompanied with a text field indicating the name of the DMR device corresponding to the associated second icon. By performing a touch operation or an operation of the pointing device, for example, by performing an operation such as drag & drop, the user can associate the first icon 600 with any one of the second icons 601, 602 and 603. The control module 235 selects the DMR device indicated by the second icon associated with the first icon 600 as a destination device. The capture and encode of the video data, which is currently played back on the video window 500B, are started, and the encoded video data is transmitted to the DMR device which has been selected as the destination device.

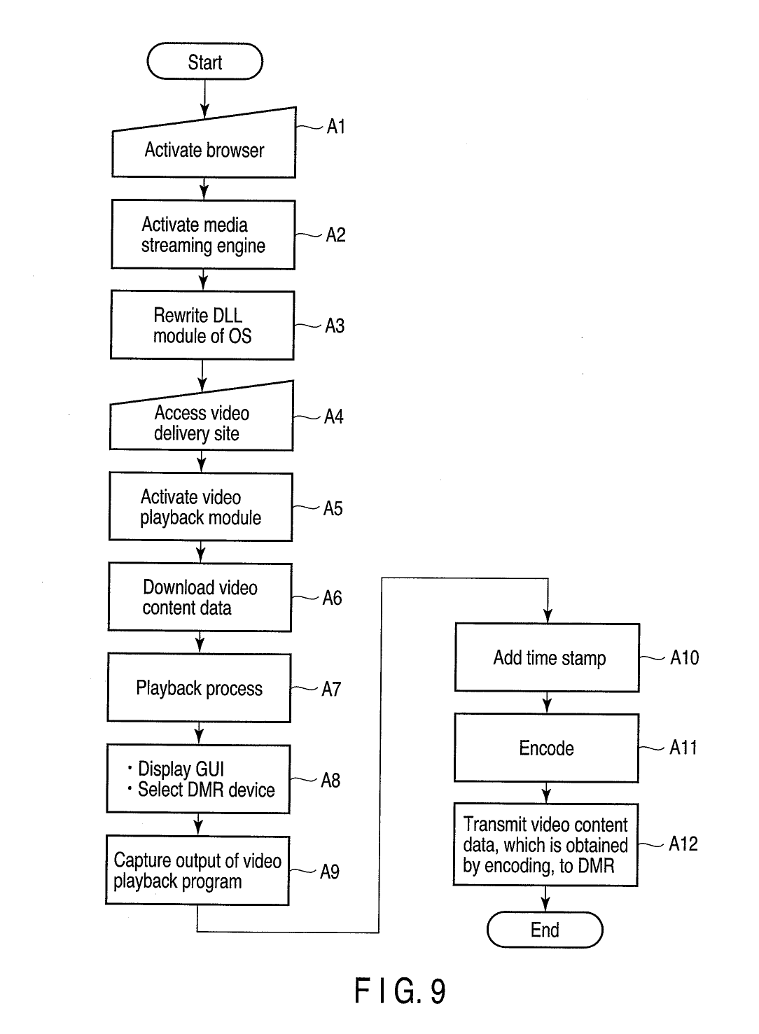

Next, referring to a flow chart of FIG. 9, a description is given of the procedure of the streaming process executed by the computer 1 of the embodiment.

When the browser 210 is started by a user operation (step A1), the browser 210 first loads the media streaming engine 230 in the memory 13 and starts the media streaming engine 230 (step A2). In step A2, the media streaming engine 230 is loaded in the memory 13 and executed. The capture control module 231 of the media streaming engine 230 executes, for example, rewrite of the DLL 102 of the OS 100, in order to acquire video data and audio data (step A3).

If the user views a Web page of the video delivery site 2 by the browser 210 (step A4), the browser 210 starts the video playback program 220 embedded in the browser 210 as plug-in software (step A5). If the user performs an operation to instruct the start of playback of certain video content data on the Web page, the video playback program 220 starts download of this video content data (step A6). While downloading the video content from the video delivery site 2, that is, while receiving the video content from the video delivery site 2, the video playback program 220 plays back the video content data (step A7). In the playback process, the video playback program 220 extracts the encoded video data and encoded audio data from the video content data, and decodes the encoded video data and encoded audio data. The decoded video data and decoded audio data are sent to the OS 100. Video corresponding to the decoded video data is displayed on the video window 500B disposed in the window 500A of the browser 210.

When the mouse cursor is moved onto the video window 500B by the user operation, the media streaming engine 230 displays the above-described GUI on the display screen 500, and selects the DMR device, which is to be set as the destination device, in accordance with the user's operation of the GUI (step A8). In step A8, the media streaming engine 230 first displays the first icon 600 on the display screen 500. If the first icon 600 is selected by the user, the media streaming engine 230 searches a DMR device on the network by using the UPnP function. The media streaming engine 230 displays second icons on the display screen 500 in association with discovered DMR devices, respectively. If the user designates one of the second icons, the media streaming engine 230 selects the DMR device corresponding to the designated second icon as the destination external device.

The media streaming engine 230 starts capturing video data and audio data which are output from the video playback program 220 (step A9). The media streaming engine 230 adds time information to the captured video data and audio data (step A10), and encodes the captured video data and audio data, thereby generating video content data which can be decoded by the selected DMR device (step A11). The media streaming engine 230 instructs the selected DMR device to play back the generated video content data, and transmits the generated video content data to the selected DMR device (step A12).

As has been described above, according to the present embodiment, while the video playback program 220, which decodes the encoded video content data received from the server such as the video delivery site, is being executed, the decoded video content data, which is output from the video playback program 220, is captured. The captured video content data is encoded, and the encoded video content data is transferred to the external device such as a TV. Thus, video content data of various encoding schemes, which are received from the server such as the video delivery site 2, can be viewed not only by the computer 1, but also by the TV 5.

The streaming function of the embodiment is realized by the computer program. Thus, the same advantageous effects as with the present embodiment can easily be obtained simply by installing the computer program into an ordinary computer through a computer-readable storage medium which stores the computer program, and executing the computer program.

In the embodiment, the case has been described, by way of example, in which the video content data received from the video delivery site 2 comprises both the encoded video data and encoded audio data. Alternatively, the video content data received from the video delivery site 2 may comprise only the encoded video data.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to execute player software for decoding encoded video content data received from a server, comprising:
a display device configured to display video of the decoded video content data;
a capture module configured to capture the decoded video content data;
an encoder configured to encode the captured video content data; and
a transfer module configured to transfer the encoded video content data to an electronic device configured to play back video content data received from an external device.

2. The information processing apparatus of claim 1, wherein the transfer module is configured to instruct the electronic device to play back the encoded video content data.

3. The information processing apparatus of claim 1, further comprising a search module configured to search the electronic device configured to play back the video content data,
wherein the transfer module is configured to transfer the encoded video content data to the searched electronic device.

4. The information processing apparatus of claim 1, wherein the player software is plugged in a browser for accessing a site on the Internet, and a window of the browser comprising a video display area for displaying video of the decoded video content data is displayed on a screen of the display device.

5. The information processing apparatus of claim 1, further comprising a control module configured to display a graphical user interface on a screen of the display device and to control start and stop of transfer of the encoded video content data to the electronic device, in accordance with a manipulation of the graphical user interface by a user.

6. A video content data playback method comprising:
decoding encoded video content data received from a server, in an information processing apparatus;
displaying video of the decoded video content data on a display device of the information processing apparatus;
capturing the decoded video content data;
encoding the captured video content data; and
transferring the encoded video content data to an electronic device configured to play back video content data received from an external device.

7. The video content data playback method of claim 6, wherein the transferring comprises instructing the electronic device to play back the encoded video content data.

8. The video content data playback method of claim 6, further comprising searching the electronic device configured to play back the video content data,
wherein the transferring comprises transferring the encoded video content data to the searched electronic device.
